(19) United States
(12) Patent Application Publication
(10) Pub. No.: US 2015/0254423 A1
(43) Pub. Date: Sep. 10, 2015

(54) COMPUTER-BASED PRESCRIPTION SYSTEM FOR MEDICAMENTS

(71) Applicant: Peter Schaub, Muenchen (DE)

(72) Inventor: Peter Schaub, Muenchen (DE)

(21) Appl. No.: 14/197,664

(22) Filed: Mar. 5, 2014

(51) Int. Cl. G06F 19/00; H04L 9/30; H04L 9/32

(52) U.S. Cl. CPC G06F 19/3456; H04L 9/3263; H04L 9/3247; G06F 19/36; H04L 9/30

(57) ABSTRACT

In a method and system for processing and exchanging prescription data in a distributed network system that includes a database, a medical server, a smartphone and a provider, such as a pharmacy's computer. The medical server may be operated by a physician, who issues a prescription for a respective patient. The medical server is adapted to generate a prescription package and to transmit the package over a second network to a mobile device, which is associated with the patient. The mobile device includes a prescription module that is adapted to generate a prescription dataset for transmission to the provider. The provider in turn resolves the received dataset by extracting an identification of a digital certificate, and generates a medication dataset, which may be sent to the mobile device.

### BACKGROUND OF THE INVENTION

1. Field of the Invention

The present invention pertains to the digital and computer-based control of prescriptions for medical applications and services.

2. Description of the Prior Art

In medical technology and in medicine modern systems more and more are computer-based. A core approach is to reduce costs due to an automation of the processes involved with medical applications. A typical scenario is that a patient requires a medication or a medical application, like an orthopedic therapy or a massage and therefore consults a physician. The physician, usually, will generate a prescription, which is part of a health-care program that governs the plan of care for the individual patient and is implemented by a qualified practitioner, like a physician, dentist, nurse practitioner, pharmacist, psychologist, or other health care providers. Prescriptions may include orders to be performed by a patient, caretaker or therapist and nowadays usually refer to an order that a pharmacist dispenses and that a patient takes, like certain medications. Prescriptions have legal implications, as they may indicate that the prescriber takes responsibility for the clinical care of the patient and in particular for monitoring efficacy and safety.

Prescriptions may be handwritten on preprinted prescription forms that are assembled into pads, or printed onto similar forms using a computer printer. In some cases, a prescription may be entered into an electronic medical record system and transmitted electronically (via an internet connection) to a pharmacy. However, the problem arises, that the patient is no longer free to select his pharmacy he wants. The patient should be involved in transmitting the prescription (in analog or digital form) to the pharmacy. Alternatively, a prescription may be transmitted from the physician to the pharmacist verbally by telephone, although this practice may increase the risk of medical error and, again, the patient is not involved in this transmission process. A major drawback of conventional systems is that problems may arise, in case the pharmacy may not provide the respective medication (in due time), because for example being out of stock for at least one medication on the prescription. In this case the patient should be free to look for another option to get the medication in time.

Therefore, there is a demand for an automated system for processing and exchanging prescription data and for an electronic data exchange in the context of medical prescriptions which is secure and protected against attacks. Further, the patient should be able to control the process of providing the medical product.

### SUMMARY OF THE INVENTION

The invention is based on the finding that information technology and in particular encryption techniques may be combined with the process of medical prescription in a manner that a synergistic effect may arise.

According to an aspect the present invention refers to a method for processing and exchanging prescription data in a distributed network system, comprising:
a database, exchanging data via Internet a medical server
a mobile device, wherein the medical server is in data exchange with the mobile device via a short range communication network, e.g. NFC, and
a provider,
   wherein the method comprises the steps of:
Sending a digital certificate, comprising a private key associated to a physician at a medical server, from the database to the medical server via internet (secure transmission)
Applying the digital certificate by the medical server for generating a signed prescription package for a respective user and sending the generated signed prescription package to the user's mobile device via short range communication, e.g. NFC
Receiving the signed prescription package on the mobile device
On the mobile device: sending the prescription dataset to the provider via a short range communication, e.g. NFC
On the provider: Receiving the prescription dataset and extracting the identification of the digital certificate
By the provider: Accessing the database with the identification of the digital certificate in order to retrieve and receive the corresponding public key
On the provider: Applying the received public key on the received prescription dataset for verification and in case of verification:
generating a medication dataset.

Further, the invention relates to a system for processing and exchanging prescription data in a distributed network system, comprising:
A database, which is adapted to administer or manage certificates and keys for data exchange between the database, the medical server and the provider and which communicates via internet
A medical server with a server module, which is received from the database via internet (as first network) and which is adapted to provide prescription functionality on the medical server
A mobile device with a prescription module, which is received from the database via internet and which is adapted to provide prescription functionality for the mobile device
A provider with a provider module, which is received from the database via internet, and which is initiated to provide prescription functionality for the provider,
wherein the medical server is in data exchange with the mobile device via a second network, being a short range communication network (e.g. NFC) and wherein the server module of the medical server is adapted to receive a digital certificate from the database and to apply the digital certificate for generating a signed prescription package for a respective user and to send the generated and signed prescription package to the mobile device,
wherein the prescription module of the mobile device is adapted to receive the signed prescription package, received from the medical server in order to generate a prescription dataset and to send the prescription dataset to the provider via a short range communication network, e.g. NFC,
wherein the provider module of the provider is adapted to receive the prescription dataset and to extract an identification of the digital certificate from the prescription dataset for accessing the database in order to retrieve and receive a corresponding public key, which is uniquely associated to the digital certificate identification and wherein the provider module is further adapted to apply the received public key on the received prescription dataset for verification and in case of verification: to generate a medication dataset.

Moreover, the invention relates to a medical server and a provider and methods for operating the server and the provider.

Further, the device nodes are adapted to perform all steps as claimed in connection with the corresponding method which is to be performed in the corresponding device or network node, like the server, the provider, the mobile device or the database. The advantages, features and alternative embodiments which are claimed or described with respect to the method for operating the system, in particular to a method for processing and exchanging prescription data in a distributed network system may also be applied and transferred to the respective apparatus or system claims and vice versa. This is based on the finding in computer science that a software application may also be implemented as a hardware application, for example in the form of an embedded processor to be deployed in a mobile device, like a smartphone or in a computer of a medical server of a physician or clinic.

### BRIEF DESCRIPTION OF THE DRAWINGS

FIG. 1 schematically shows an infrastructure for a prescription system in a context of other entities according to an embodiment of the invention.

FIG. 2 is a flow chart of a method for operating the system according to an embodiment and which is executed on different network nodes.

FIG. 3 is a flow chart of a method for operating a medical server according to an embodiment.

FIG. 4 is a flow chart of a method for operating a mobile device according to an embodiment.

FIG. 5 is a flow chart of a method for operating a provider, in particular a pharmacy, according to an embodiment.

### DESCRIPTION OF THE PREFERRED EMBODIMENTS

In the following description, for purposes of explanation and not limitation, specific details are set forth, such as particular prescription environments and network standards etc., in order to provide a thorough understanding of the current invention. It will be apparent to one skilled in the art that the current invention may be practiced in other embodiments that depart from these specific details. For example, the skilled artisan will appreciate that the current invention may be practiced with any short range communication network, like for example near field communication (NFC) or Bluetooth. As another example, the invention may also be implemented, in any mobile device, having the respective interfaces, like a smartphone, a mobile phone, a mobile computer system, or a personal digital assistant.

For summarizing, it is proposed to provide an automated prescription system, wherein prescription related data are exchanged in digital form automatically and protected against attacks. The process of getting a prescription filled or of providing a medical product for a patient after issuing the prescription by the physician or health care provider is controlled by the patient himself in electronic form.

According to an aspect the present invention relates to a method for processing prescription data in electronic or digital form. The prescription will be written out by a physician and will be provided (and optionally stored) in an electronic record or dataset. This prescription dataset will be provided on a medical server which is related to the physician of a patient. The patient has a mobile device (e.g. smartphone). The prescription data is processed by the medical server to generate a prescription package, which is transferred via short range communication network (e.g. NFC), to the patient's smartphone. The smartphone, in turn, receives the package, which may contain one or more signed medication datasets. The patient usually is identical with the user of the smartphone. However, it is also possible that the patient is not directly managing the provision of his medicine, but a person acting on behalf of him. Then, the patient is associated to the mobile device.

According to an embodiment of the invention the prescription dataset is different from the prescription package. The smartphone sends the prescription dataset to a provider, which may be a selected pharmacy according to the patient's preferences. The pharmacy's computer, called provider, processes the received prescription dataset(s) by accessing a central database. The database may be operated on or behalf of an Association of Statutory Health Insurance Physicians. The pharmacy processes the data and verifies whether the prescription received with the prescription dataset indeed is authorized by a physician for the specific patient. This processing is executed automatically. Further, the pharmacy will evaluate whether or not it has the medical products the prescription dataset it refers to on stock. If the products are available, the product will be handed over to the patient and a medication dataset will be generated as well and transmitted to the smartphone of the patient. The medication dataset may comprise a digital representation of the name of the medical product, information of use, a best-before date, price information and a package insert of the pharmaceutical.

In the following a definition of terms used within this application is given.

As medical practice has become increasingly complex, the scope of meaning of the term “prescription” has broadened to also include clinical assessments, laboratory tests, and imaging studies relevant to optimizing the safety or efficacy of medical treatment. The content of a prescription may include the name and address of the prescribing provider and any other legal requirement such as a registration number (e.g. DEA Number in the United States).

The distributed network system comprises different computer-based nodes or computer-based devices, which are in data exchange over at least one network. The different network nodes comprise a central database, which may be operated by or on behalf of an association of medical physicians. Further, the network comprises a medical server, which may be operated by a physician or by a hospital or hospital department, and further comprises a mobile device, in particular a smartphone, which is uniquely associated to a patient. The network further comprises a provider, which may be a pharmacy, a drugstore or a provider of medical products and applications (for example like massages and the like).

All the different network nodes, in particular the database, the medical server, the mobile device and the provider may be processing entities for digital data processing. The nodes may be implemented as processors, computers, workstations or computer networks and may comprise a plurality of separate computer-based instances. The mobile device may be a mobile terminal, like a mobile phone or another electronic device which has at least two interfaces: a wireless network interface, e.g. for internet access and a second interface for a communication via second network, being a short range communication network, in particular a near field communication network (NFC network). However, a skilled person in the art will understand that also other short range communication networks may be applied for the present invention, like for example Bluetooth network.

In order to provide a secure and safe data exchange between the respective network nodes, the data processing is based on an asymmetric cryptography method, also referred to as public-key encryption. These methods are based on a cryptographic algorithm which requires two separate keys, a public key and a different private (or secrete) key. These keys are generating a key pair and are linked via a mathematical function. The public key may be used to encrypt data or plaintext. Further, the public key may also be used to verify a digital signature. The private key is used to decrypt ciphered text or to create a digital signature. The term “asymmetric” stems from the usage of the public and private key to execute opposite or inverse functions of the underlying cryptographic algorithm. Thus, in these asymmetric algorithms the key for encrypting the message on the sender side is different from the key to decrypt the message on the receiver's side. Generally, the private key is kept secret, whereas the public key may be distributed among the network nodes. More detailed information about public key cryptography may be found in IEEE 1363: Standard specifications for public-key cryptography.

The cryptography system, which is used in the present invention, may be executed by using and accessing a certificate authority, which is a trusted third party instance, which is responsible for the key pair (public, private) and for verifying the identity of the key users. One example of a public key infrastructure (PKI) is described in the standard ITU-T X.509.

As described above, in a preferred embodiment, an asymmetric encryption algorithm is used for signing the prescription package. However, in alternative embodiments it is also possible to use symmetric algorithms in which the key for encryption and the key for decryption are the same. Typically, a key exchange is necessary between the respective communication nodes or parties.

The term “digital certificate” refers to a public key certificate. The certificate refers to an electronic file or document that uses the digital certificate to bind the digital certificate as public key with the sender's identity, which in this case is identical with the medical server of the physician who has written out the prescription. According to an embodiment the certificate is managed and administered by a center certificate authority (CA). According to another embodiment the certificate is a self-signed certificate. In the latter case, the certificate represents an attestation by the certificate signer or sender that the identity information and the public key belong together. According to an embodiment of the invention the digital certificate is used to sign the message and certify that the message, which is going to be sent by the medical server, stems or belongs to the respective physician who is working at and related to the medical server. According to an aspect the digital certificate is associated to a doctor working at the medical server. It is also possible to associate the digital certificate for a set of doctors or physicians working with the medical entity, as a group certificate.

The internet uses an http protocol or other http-related protocols as interface. Alternatively, it may be possible that the respective nodes (database, medical server, provider) interact by means of another wireless network.

The second network is a short range communication network and may relate to a near field communication network (NFC) or to any short range communication network. NFC is a bi-directional radio communication system between NFC-enabled devices, which operates in the radio frequency band of 13.56 MHz. Predetermined electromagnetic-wave carriers modulated using digital data are transmitted, the transmitted electromagnetic waves are received by an antenna, and the digital data modulated on the carrier signal is demodulated. NFC may be half-duplex communication in which two devices transmit electromagnetic waves of a common frequency. Alternatively, NFC may be full-duplex communication in which two devices transmit electromagnetic waves of differing frequencies. An allowable NFC communication distance is typically about 10 cm. NFC can be used to quickly establish other types of wireless communications between devices without the usual lengthy setup procedures, acting as a virtual connector, enabling devices to communicate at longer ranges or transfer data at higher rates.

According to the invention at least three different prescription-related massages or datasets are used:

1. the prescription package,

2. the prescription dataset and

3. the medication dataset.

A prescription package is generated on the medical server and uses the digital certificate, which has been received from the database or from a central certifying authority. The prescription package consists of several data fields or items, comprising: the name of the medical product or pharmaceutical, information of use relating to the medication, information relating to the package size. These data items are transmitted in the prescription package as a plain text and are visible for the sender and for the receiver as well. The prescription package, further, may comprise signature information and a certificate identification number (in short: ID, which refers to the identification of the digital certificate). The digital certificate itself, or an identification of the digital certificate, is included in the prescription dataset in unsigned form (i.e. original form, plain text). Although the signed data items are signed, they may be visible for sender and receiver of the message. The signed data items inter alia refer to the items, which have been mentioned above, which are transmitted as plaintext (name of the medication, package size, usage) and name and prename of the patient as well as birth date and address of the patient (for verification purposes). In this respect it has to be pointed out that the prescription package contains data items relating to the medication, the digital certificate itself and data items relating to the patient for whom the prescription is written. Of course it is possible that a prescription relates to more than one medication. In this case the prescription comprises several datasets for the different medications. It has to be noted that each medication is represented by a separate data entry, comprising medication-related data or information in plaintext, a patient ID (name, date of birth) and the digital certificate ID and signature information with respect to the medication and with respect to the patient. The prescription package is sent from the medical server to the mobile device of the respective patient e.g. via near field communication.

The prescription dataset is generated on the mobile device and is sent from the mobile device to the provider, being implemented as computing node of a pharmacy. According to a preferred embodiment the prescription dataset differs from the prescription package. According to an embodiment, the prescription dataset comprises the medication (plain text), the digital signature information (stemming from the medical server and transmitted to the mobile device with the prescription package) and an identification (ID) of the certificate. According to an aspect the prescription dataset further comprises medication related data and patient related data, both datasets are signed. According to a further embodiment, said signed information may additionally be encrypted, in order to enhance security of data transmission over public networks, so that this information will not be visible in case the data transfer between medical server and mobile device gets corrupted. The prescription dataset is sent via the near field communication network to the pharmacy. According to another embodiment, the prescription dataset comprises of further items. Alternatively, it is also possible that the prescription dataset is identical to the prescription package. Further, it is possible that the prescription dataset comprises additional time-related data or patient-related data (for example preferences of the patient in case that several medications are available).

On the side of the provider (pharmacy) the prescription dataset is processed in order to extract the identification of the digital certificate. The extracted digital certificate identification is used for verification. In particular, the provider accesses the database with the digital certificate identification in order to retrieve the corresponding public key for verification the received prescription dataset. It has to be noted that prior to deciphering the medication-related information in the prescription, the dataset is not provided in human-readable format as it is coded and signed. Thus, it is not possible, that the provider decodes and reads the medication information until a positive verification at the provider has been proven. Subsequently, the provider may access its internal stock management system in order to have a look-up in the internal supply database whether or not the required medication is available in said pharmacy.

In case the medication is available at the provider, the provider amends the received prescription dataset and generates a new dataset, namely a medication dataset. The medication dataset differs from the prescription dataset as additional data items are added. The additional data items refer to a best before use information relating to the medication and optionally a local link to package insert, an enclosed label or to information and direction for use relating to the medication. Other embodiments relate to other additional datasets relating to further information for the patient with respect to the medication. According to another embodiment the additional information (as mentioned before, comprising at least: best before use information, local link to package insert) may be provided in the medication dataset by replacing the signed information, which has been included from the medical server in signed form and which has been transmitted by the mobile device in signed form, too. According to an embodiment the medication dataset, thus, comprises medication-related information (e.g. the name of the medication, use information and package information and information for use relating to the medication) and a best before use information and a local link.

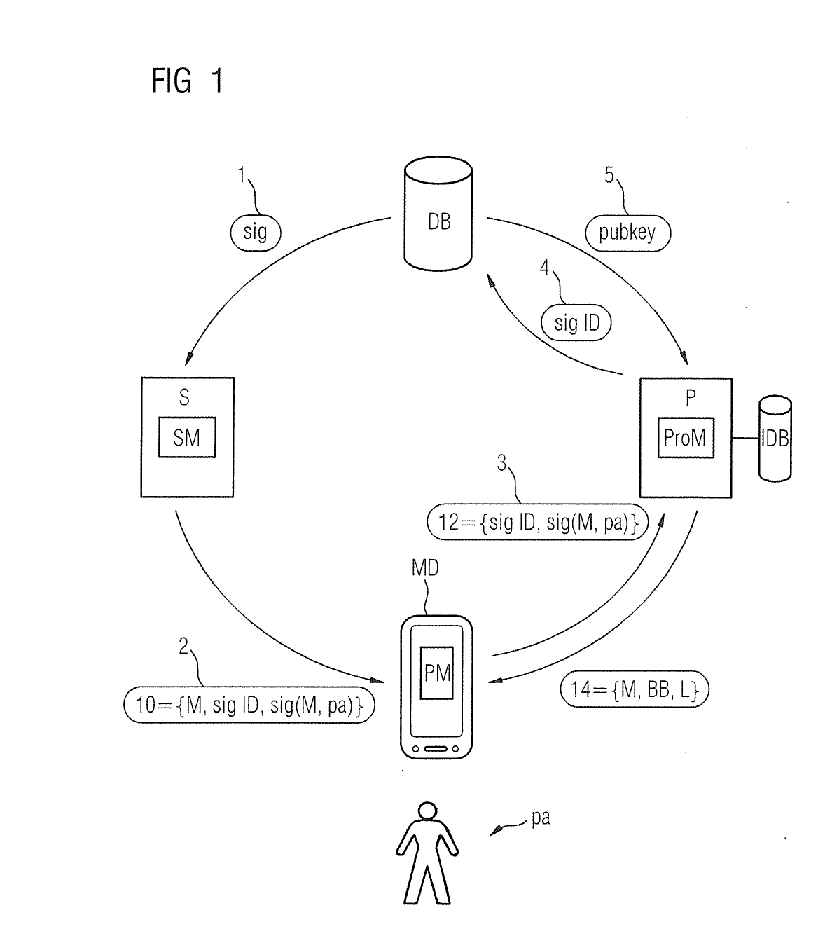

An example of the infrastructure for a system for processing and exchanging prescription data is described with respect to FIG. 1 below.

A database DB serves as a central control unit. The database DB may interact with a certificate authority or may consist of a key administration unit. Further, the database DB acts as server for providing the other computer network nodes, inter alia a medical server S, a mobile device MD and a provider P with the respective software modules, which may be provided via download. In particular, the medical server S may download a server module SM, the mobile device MD may download a prescription module PM and the provider P may download a provider module ProM. The respective modules SM, PM, ProM are adapted to provide the respective computer-based instances with a prescription functionality. The respective modules may be implemented as software and/or hardware modules on the respective devices (the server S, the mobile device MD and the provider P).

As can be seen in FIG. 1, in a first step the digital certificate sig is sent from the database DB to the medical server S. Generally, in FIG. 1 the sequence of method steps is represented by numbers in a circle.

After having received the digital certificate sig on the medical server S of the physician, who wants to write out a prescription for a respective patient, which in FIG. 1 is represented as a user of the mobile device MD. The server module SM of the medical server S generates a prescription package 10. The prescription package 10 comprises medication-related information M in plain text (visible and unsigned) and an identification of the digital certificate sigID in unsigned form and data items in signed form. The signed data items refer to the medication-related data M and patient-related data pa. The patient-related data pa comprise name of the patient, prename of the patient, birth date of the patient, address of the patient and optionally other patient related data. The medication-related data items M comprise name of the medication, dose requirements of the medication, number or amount of the medication and optionally other medication related data. The prescription package 10 is transferred from the medical server S to the mobile device MD via near field communication.

After having received the prescription package 10 on the prescription module PM of the mobile device MD the mobile device MD generates the prescription dataset, which in the Figure is referenced with numeral 12. The prescription dataset 12 comprises the signed information of the prescription package 10. Alternatively, the prescription dataset 12 may also comprise additional information. The prescription dataset is generated by means of the prescription module PM on the mobile device MD. In a third step, the prescription dataset 12 is transferred via NFC communication to the pharmacist's computer, being the provider P. The provider module ProM receives the prescription dataset 12 and processes it. In particular, the provider module ProM extracts the identification of the digital certificate sigID and accesses with this identification of the digital certificate sigID the central database DB in order to provide a corresponding public key pubkey, being associated to the digital certificate sig. This step may be used for verification. In particular, the digital certificate sig is used to approve the received information.

In case of missing verification, a fault signal may be provided. The fault signal may be provided on the provider P and/or on the mobile device MD and/or on the medical server S.

In case of verification, the provider module ProM looks up a local database IDB whether or not the medication is on stock. In case the medication is on stock it is handed out to the patient. Otherwise, the patient may be informed about scheduled delivery data and/or alternative medications. This information may be provided to the mobile device MD via a message to be received on his mobile device MD. Further, the provider module ProM generates a medication dataset 14 in the sixth step. The medication dataset 14 comprises medication-related data in plaintext and best before use data BB and an electronic version of a package insert L. The latter may be provided as link and/or download link and/or may be directly incorporated in the medication dataset 14. The medication dataset is transferred to the prescription module PM of the mobile device MD.

According to advantageous embodiments it is possible to extend the system in that the mobile device MD automatically transfers the medication dataset 14 or at least a part of the medication dataset 14 to a medical insurance company for the purpose of compensation. Further, it is possible that the medical server S is informed about the handing out of the medication to the patient. Said information of the server S may be triggered by the provider P and/or by the mobile device MD.

As can be seen in FIG. 1 the database DB exchanges data with the medical server S and with provider P via the first network, which may be the internet. The mobile device MD may also be in data exchange with the database DB via internet, in particular for downloading the prescription module PM. The medical server S is in data exchange with the mobile device via the second network, in particular via NFC communication. NFC communication is also used for data exchange between the mobile device MD and the provider P, being the pharmacist's computer. It has to be noted, that the first network (internet) and the second network are completely different networks. This is essential for providing a secure and safe transmission of prescription-related data items.

Before starting the prescription process a configuration phase may be executed. The configuration phase comprises downloading the server module SM from the database DB to the medical server S, downloading the prescription module PM to the mobile device MD and downloading the provider module ProM on the provider P. All modules may be provided by the database DB or by another instance operated on or behalf of the database DB.

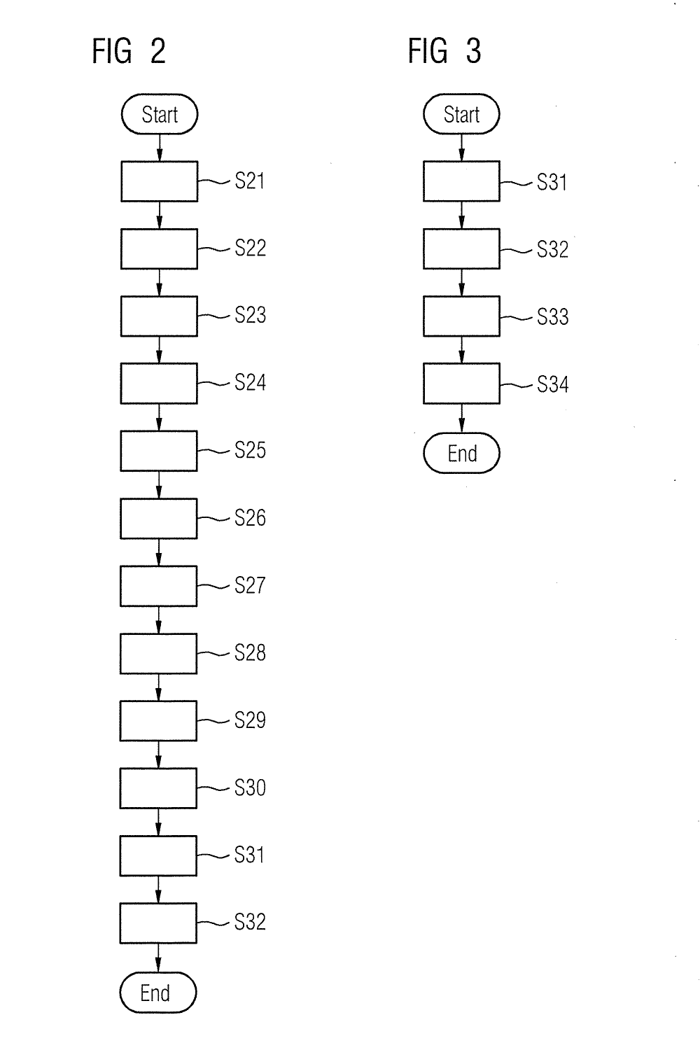

FIG. 2 shows a flowchart of a method for processing and exchanging prescription data. After starting the method and after a configuration phase, which has been described above, the digital certificate sig is sent in step S21 from the database DB to the medical server S.

In step S22 the digital certificate sig is applied by the medical server S on a prescription item or on several prescription items which are issued for a respective patient.

In step S23 a prescription package 10 is generated for the respective patient.

In step S24 the generated prescription package 10 is sent to the patient's mobile device MD via the NFC communication network.

In step S25 the prescription package 10 is received on the mobile device MD.

In step S26 a prescription dataset 12 is generated.

In step S27 the prescription dataset 12, which has been generated on the mobile device MD is sent from the mobile device MD to the provider P via NFC communication.

In step S28 the prescription dataset 12 is received on the provider P. Further, an identification of the digital certificate sigID is extracted from the prescription dataset 12.

In step S29 the database DB is accessed with the extracted signature information sigID or with the extracted signature sig itself. According to an aspect the signature information is identical with the identification of the digital certificate. A public pubkey which is provided by the central database DB is used for verification.

In step S30 the received public key pubkey is applied for verification which is executed in step S38. The verification may be executed by applying the received public key pubkey to the prescription dataset 12 for deciphering the same. In case a deciphering is possible, the verification is accepted and the medication related data are visible and provided in plain text at the provider ProM. Otherwise the verification is denied.

In case of verification, in step S32 a medication dataset 14 is generated and sent to the mobile device MD. Subsequently the method ends or may be executed iteratively.

FIG. 3 shows a flowchart for a method for operating the medical server S. Subsequent to the configuration phase the medical server may be used and prepared for processing prescription dat.

In step S31 the digital certificate sig is received at the medical server S.

In step S32 the digital certificate sig is applied in order to generate a signed prescription package 10 in step S33.

In step S34 the generated prescription package 10 is sent to the prescription module PM of the mobile device MD for further processing.

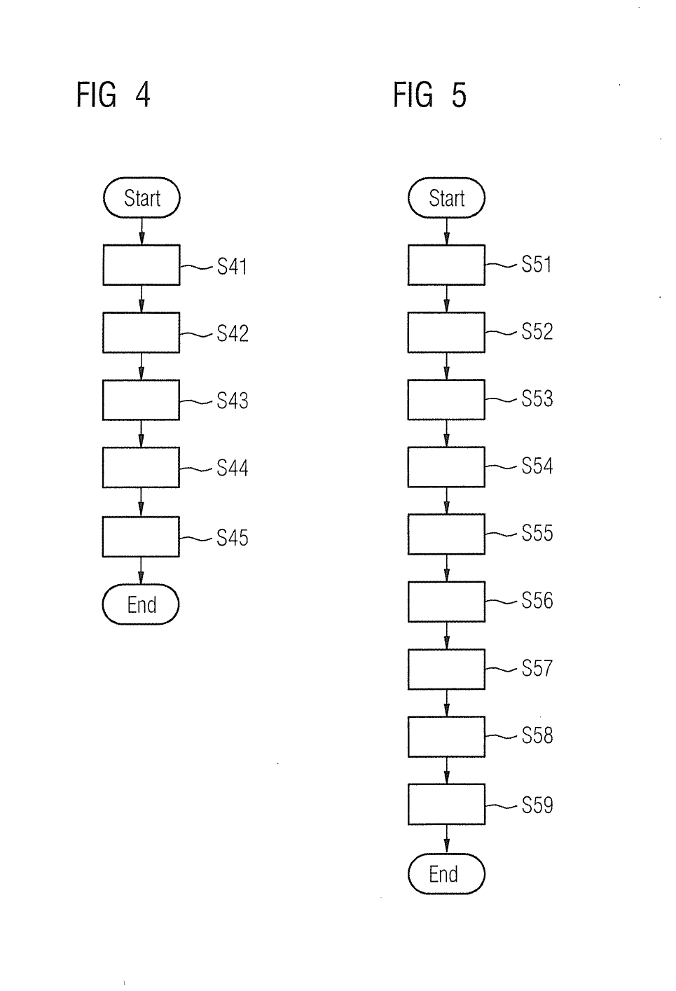

FIG. 4 shows a flowchart for a method for operating a mobile device MD.

After starting the method and after initiating the prescription module PM on the mobile device MD in step S41, the prescription module PM may be used for processing prescription data.

In the operating phase steps S42 to S45 may be executed.

In step S42 the prescription package 10 is received.

In step S43 the prescription package 10 is resolved in the prescription module PM. However, this step is not necessary. In a preferred embodiment, the identification of the digital certificate sigID and the signed data are transferred as received (unchanged) to the provider ProM. In this case the prescription dataset 12 is generated by concatenating or combining the received identification of the digital signature sigID and the signed data (which have been received with the prescription package 10) and optionally other metadata (e.g. a timestamp). Thus, the step of ‘resolving’ and ‘generating the prescription dataset 12’ may be combined or fused to one single step.

In step S44 the prescription dataset 12 is generated.

In step S45 the prescription dataset 12 is sent to the provider P via NFC communication.

FIG. 5 shows a flowchart relating to a method for operating a provider P.

After starting the method and subsequently to initiating a provider module ProM on the provider P in step S51 the steps S52 to step S59 may be executed for processing prescription data.

In step S52 the prescription dataset 12 is received on the provider P.

In step S53 the identification sigID of the digital certificate sig is extracted from the prescription dataset 12.

In step S54 the database DB is accessed with the extracted identification sigID of the digital certificate sig in order to retrieve an associated public key pubkey in step S55 on the database DB. Thus, step S55 is executed on the database DB. Subsequently to retrieving the public key pubkey on the database DB, the public key pubkey may be received on the provider P in step S56.

In step S57 the received public key pubkey may be used for verification. Verification is executed in step S58.

In step S58 the received public key pubkey is applied on the received prescription dataset 12 or a portion of the same in order to verify the signature. In case verification is not possible, verification will be refused and further processing for the respective prescription may be stopped or at least suspended (e.g. for future resuming in case another prescription dataset 12 may be verified). Otherwise it will be verified.

In case of verification, the medication dataset 14 is generated in step S59. Subsequently the method ends or may be executed for further medication items in the prescription package 10 and in the prescription dataset 12. Additionally, it is also possible to apply the method iteratively for a new prescription package.

According to a further embodiment, time-related information is provided additionally. In particular, the prescription package 10 may contain a (first) time stamp which represents the time of issuing the respective prescription. Further, a second time stamp may also be part of the prescription dataset 12, which is sent from the mobile device MD to the provider P for the purpose of informing the provider P about the generation of the prescription dataset 12. It is also possible to provide more than one time stamp in prescription-related datasets. Generally, all datasets (prescription package 10, prescription dataset 12 and/or medication dataset 14) may be stored in at least one of the computer-based nodes, comprising the medical server, the mobile device MD and the provider P.

The invention has several advantages.

Due to the specific form of data transmission it is possible that the patient may read prescription-related data in a structured form and in plaintext. Further, he may access the prescription-related data every time he wants to and has access on his mobile device MD. Further, it is possible to make sure, that the medications or medical applications, which are covered in the respective prescription may only be purchased once. This is realized in that the medication dataset 14 differs from the prescription dataset 12. Only those medical applications or medications, which have been purchased to the patient, are represented in the medication dataset 14 accordingly. Thus, medications, which have not been provided to the patient, because, for example, the medication is not on stock at the provider P, are not amended and sent back in original form in the medication dataset 14.

In another embodiment, it is also possible to transfer an additional tag in the medication dataset 14, indicating that the respective medication has been provided to the patient. This tag may also be transmitted to the medical server S. The tag may be provided in the local database IDB of the provider p in order to make sure that the same medication is not provided twice to the respective patient.

In case of an alternative medication is provided to the patient the respective dataset may be amended easily. The alternative medication is handed out the patient and a respective item in the medication dataset 14 is included, representing the alternative medication. Thus, the patient is informed about the alternative medication and the respective use information and best before use information etc:

In case the medication is not on stock at the provider P, the patient is able to select another provider P and to purchase the rest of the prescription. In this case the patient enters the second provider P and brings his mobile device MD in near field communication of the provider's computer in order to transmit the prescription dataset 12. In this case, the prescription dataset 12 comprises the rest of the medications which have not been provided to the patient. Subsequently, the second provider P executes the method steps for providing the medication to the patient as explained above.

As a major advantage it has to be stated that the method and system according to the invention may be implemented easily. It is only necessary to execute a configuration phase in order to download the modules SM, PM and ProM on the respective computers. Subsequently, prescription data processing may be executed without any further requirements. In particular, it is not necessary to have separate key exchange. Further, it is not necessary to provide additional modules or additional data processing on the side of the server S, the mobile device MD and the provider P.

The combination of features according to the invention provides a synergistic effect in that the processing of prescription data provides added value in the form of new functionality compared to the sum of the functionality of the analog prescription process according to state of the art. Added value is provided for the patient as the patient may access prescription-related data by means of his mobile phone. He does not need to evaluate a manually written prescription paper. Further, he is provided with additional information related to the prescription, inter alia with best before use information, price information and medical package insert information relating to the medication. Thus, he may access medical package insert information without the medication itself and only via his mobile device MD. Further, he may easily and without any additional steps (with one click) transmit relevant prescription data to other persons or instances, for example to his computer or workstation at home. Further, he may store package insert information on a computer storage for later use also in case the medication has been fully consumed and/or the package insert paper is not available anymore. Further, he may transmit prescription-relevant data to other computer-based instances for example to the health insurance for the purpose of cost compensation for the medication. The language of the medical package insert information may correspond to the preconfigured language of the smartphone. In another embodiment it is possible to add an additional language item to the prescription dataset 12 in order to identify the preferred language for the medication dataset 14 to be received on the mobile device MD.

The user of the smartphone might get a message on screen, if the expiration date of the medication has passed.

Further, the medication process may be simplified in case the patient may purchase the medication at an online pharmacy. In this case an online extension of the method and system according to the invention is provided. The online extension refers to the scenario in which the patient may transmit the prescription dataset 12 via a third network to the provider P. The third network may be the internet (e.g. e-mail). In this case an online module is provided in the mobile device MD. The online module is adapted to automatically generate an online transmission for the prescription dataset 12. The online transmission may be executed by means of sending an e-mail or another electronic message (e.g. SMS) to the provider P, being an online pharmacy. According to another embodiment, it is also possible to send the prescription dataset 12, which has been generated on the mobile device MD to the provider P via other means for a data transmission, like SMS.

A further advantage is to be seen in that a method and system according to the invention may be used in parallel to existing conventional prescription systems, which are based on a manual prescription. The coexistence of conventional prescription systems with the prescription system according to the invention may reduce costs and may provide flexible application of the invention.

An additional value may also be provided for the provider P, because the provider P may store prescription-related data and/or patient-related data in the local database IDB. The stored datasets may be used for later orders. For example, the provider P may store the information, that the patient A has problems with allergy after consuming a specific medication Y. This dataset may be stored locally at the provider's database IDB, so that in case of future orders it can be make sure that the medication Y is no longer provided for the patient A, because of causing the allergy. Automatically options for the medication Y may be provided.

An additional value may also be provided for the medical server in that prescription-related data may also be stored at the server's site. Prescription-related data may be stored as case history or in the context of anamnesis data. The health care provider of physician, therefore, may always access information at what time which medication has been issued for the respective patient. This information is not available according to conventional prescription systems.

According to an embodiment of the present invention it is also possible to transmit the prescription package via QR-code to the mobile device MD. The QR abbreviation relates to quick response code and refers to two-dimensional barcode, which is machine-readable and may be processed digitally. All major mobile operating systems, like Android, Blackberry and Apple iOS support the QR-code system, so that it is possible to read a QR-code and to resolve the respective information transmitted therein. Also a so-called barcode reader may be downloaded from an external source on the mobile device for the purpose of providing a QR interface on the mobile device. Further embodiment relates to transmitting an encrypted QR-code for the purpose of safety. For further information relating to the QR-code it is referred to the U.S. Pat. No. 5,726,435 in the name of Denso Wave. Generally, the QR-code embodiment of the present invention may be applied in scenarios in which the patient will not change the received prescription package 10 for transmission to the provider P. Thus, the prescription package 10 identically corresponds to the prescription dataset 12.

A person skilled in the art will understand that according to the invention a handwritten prescription (in conventional form) is transferred to a different state, namely in an electronic version of the prescription. Further, it has to be noted that the server S, the mobile device MD and the provider P are amended and show a different structure and architecture as specific modules SM, PM, ProM are provided on the respective computers.

Further, a skilled person in the art will understand that the present invention relates to a network system, requiring computers for execution, namely a medical server computer, a mobile device, like a smartphone with embedded processor and a provider computer. Additionally, a central database may be provided, too. It is not possible to execute the invention without the computer instances, because it is necessary to transmit the prescription-related datasets in form of a prescription package 10, a prescription dataset 12 and a medication dataset 14. Therefore, the system and the method are tied to a particular computer machine or apparatus, like the mobile device MD.

Further, it has to be noted that the present invention does not relate to an abstract idea, because the medical server S, the mobile device MD and the provider P are adapted specifically for processing prescription-related data.

Further, the conventional prescription process according to state of the art methods is improved significantly as up to now, the patient needs to take different actions with respect to his prescription. First, he has to receive the manual or handwritten prescription. Then he has to bring this handwritten paper to his pharmacy and to receive the medication. Subsequently, he has to initiate a new process for transmitting the prescription-related data to his health insurance. Usually, he has to make a copy of the prescription document and has to send the copy to the insurance company. The present invention provides a solution in that it is no longer necessary to initiate these different actions. It is possible to receive the medication only by one click (and/or touch on a touch screen) on his mobile device. A patient, who has received prescription-related data in digital form, in particular via the prescription package 10, may initiate further processes only via his mobile device MD by clicking a user interface element. By activating only one button on the user interface an automatic processing of prescription-related data is activated. In particular, the prescription dataset 12 is generated automatically and sent to the provider P for further processing.

Further, means are provided to exchange data between the medical server S of a physician and the pharmacy for the provider P, respectively.

While the instant invention has been described in relation to its preferred embodiments, it is to be understood that this description is for illustrative purposes only. Accordingly, it is intended that the invention be limited only by the scope of the claims appended hereto.

I claim as my invention:

1. A method for processing and exchanging prescription data in a distributed network system comprising a database, exchanging data via internet, a medical server, a mobile device, wherein the medical server is in data exchange with the mobile device via a second network that is a short range communication network, and a provider, said method comprising:
sending a digital certificate from the database to the medical server via internet;
applying the digital certificate by the medical server for generating a signed prescription package for a respective user and sending the generated signed prescription package to the user's mobile device via a short range communication network;
receiving the signed prescription package on the mobile device;
on the mobile device, generating a prescription dataset and sending the prescription dataset to the provider via the short range communication network;
on the provider, receiving the signed prescription dataset and extracting an identification of the digital certificate;
via the provider, accessing the database with the identification of the digital certificate in order to retrieve and receive a corresponding public key; and
on the provider, applying the received public key on the received prescription dataset for verification and in case of verification: generating a medication dataset.

2. The method according to claim 1, further comprising:
sending the medication dataset or at least a part of it from the provider to the mobile device via the second network.

3. The method according to claim 1, further comprising:
providing a server module on the medical server which is adapted to provide prescription functionality on the medical server.

4. The method according to claim 1, further comprising:
initiating a provider module on the provider, which may be received from the database via internet, and which is adapted to provide prescription functionality for the provider.

5. The method according to claim 1, further comprising:
initiating a prescription module on the mobile device, which may be received from the database via internet, and which is adapted to provide prescription functionality for the mobile device.

6. The method according to claim 1, wherein the data exchange between the provider and the database is executed via internet.

7. The method according to claim 1, wherein the prescription package relates to at least one medical prescription for a patient, who is associated to or identical with the user of the mobile device.

8. The method according to claim 1, wherein the prescription package comprises at least one dataset relating to a medical product and a signed form of the at least one dataset relating to medical product, an identification of the digital certificate and an identity information of the patient who is identical with or associated to the user of the mobile device.

9. A system for processing and exchanging prescription data in a distributed network system, comprising:
a database adapted to administer certificates and keys for data exchange between the database, a medical server, and a provider;
the medical server comprising a server module, which is received from the database via the internet and which is comprised to provide prescription functionality on the medical server;
a mobile device comprising a prescription module, which is received from the database via the internet and which is configured to provide prescription functionality for the mobile device;
the provider comprising a provider module, which is received from the database via the internet, and which is initiated to provide prescription functionality for the provider;
the medical server being in data exchange with the mobile device via a second network, being a short range communication network, and the server module of the medical server being configured to receive a digital certificate from the database and to apply the digital certificate for generating a signed prescription package for a respective user and to send the generated signed prescription package to the mobile device,
the prescription module of the mobile device being configured to receive the signed prescription package, received from the medical server in order to generate a signed prescription dataset and to send the signed prescription dataset to the provider via the second network; and
the provider module of the provider being configured to receive the signed prescription dataset and to extract an identification of the digital certificate from the prescription dataset for accessing the database in order to retrieve and receive a corresponding public key, which is uniquely associated to the digital certificate, and the provider module being further configured to apply the received public key on the received prescription dataset for verification and upon verification, to generate a medication dataset.

10. A medical server for processing and exchanging prescription data in a distributed network system, wherein the medical server comprises a server module, which is received from a database via internet or another interface and which is adapted to provide prescription functionality on the medical server, and wherein the medical server is in data exchange with a mobile device via a second network, being a short range communication network and where-in the server module of the medical server is configured to receive a digital certificate for the medical server from the database and to apply the digital certificate for generating a signed prescription package for a respective user and to send the signed prescription package to the mobile device of the user.

11. A method for operating a medical server for processing and exchanging prescription data in a distributed network system, the method comprising:
receiving a digital certificate for the medical server from a database via the internet; and
applying said digital certificate in order to generate a signed prescription package for the respective user of the mobile device and to send the generated prescription package to the mobile device of the user via a second network, being a short range communication network.

12. A mobile device for processing and exchanging prescription data in a distributed network system, the mobile device comprising a prescription module, which is received from a database via internet and which is configured to provide prescription functionality for the mobile device, and wherein the prescription module of the mobile device is configured to receive a prescription package, received from a medical server via a second network that is a short range communication network, in order to generate a prescription dataset and to send the signed prescription dataset to a provider via the second network.

13. A method for operating a mobile device for processing and exchanging prescription data in a distributed network system, the method comprising:
initiating a prescription module on the mobile device, which is received from a database via download from internet, which is configured to provide prescription functionality for the mobile device;
receiving a signed prescription package on the mobile device, which has been received from a medical server via a short range communication network; and
generating a prescription dataset and sending a signed form of the prescription dataset to a provider via a second network that is a short range communication network.

14. A provider for processing and exchanging prescription data in a distributed network system, the provider comprising a provider module, which is received from a database via internet and wherein the provider module is initiated to provide prescription functionality for the provider, and wherein the provider module is configured to receive a prescription dataset from a mobile device of a user via a second network that is a short range communication network and to extract an identification of a digital certificate from the received prescription dataset for accessing a database in order to retrieve and receive a respective corresponding public key, and wherein the provider module is further configured to extract a digital certificate for verification and in case of verification: generating a medication dataset.

15. A method for operating a provider for processing and exchanging prescription data in a distributed network system, wherein the method comprising:
initiating a provider module on the provider, which is received from a database via Internet and which is configured to provide prescription functionality for the provider;
receiving a signed prescription dataset from a mobile device and extracting an identification of a digital certificate;
accessing the database with the identification of the digital certificate in order to retrieve and receive a corresponding public key; and
applying the received public key on the received prescription dataset for verification and in case of verification: generating a medication dataset.
